(19) United States
(12) Patent Application Publication
(10) Pub. No.: US 2007/0229429 A1
(43) Pub. Date: Oct. 4, 2007

(54) Liquid crystal display device and driving method thereof

(75) Inventors: Sang Hee Yu, Gyeonggi-do (KR); Sang Yeup Lee, Gyeonggi-do (KR)

Correspondence Address: MORGAN LEWIS & BOCKIUS LLP, 1111 PENNSYLVANIA AVENUE NW, WASHINGTON, DC, 20004, US

(73) Assignee: LG.Philips LCD Co., Ltd.

(21) Appl. No.: 11/633,460

(22) Filed: Dec. 5, 2006

(30) Foreign Application Priority Data
Apr. 4, 2006 (KR) P06-0030563

(51) Int. Cl. G09G 3/36

(52) U.S. Cl. 345/94

(57) ABSTRACT

A liquid crystal display device includes data lines and gate lines on a substrate intersecting each other to define a plurality of pixel areas; a plurality of liquid crystal cells formed in respective pixel areas; a data driver that generates a positive and a negative data signals, the data driver supplies desired data signals to the data lines; a gate driver that supplies a scan signal to the gate lines, wherein a voltage level of the scan signal is changed in accordance with a polarity of the data signal; and a plurality of thin film transistors formed at respective intersections of gate lines and data lines, the thin film transistor supplying the data signal to the liquid crystal cell in response to the scan signal.

This application claims the benefit of the Korean Patent Application No. P06-0030563 filed on Apr. 4, 2006 which is hereby incorporated by reference.

### BACKGROUND OF THE INVENTION

1. Field of the Invention

The present invention relates to a liquid crystal display device, and more particularly to a liquid crystal display device that improves display quality by reducing a difference in a kickback voltage when the LCD device is operated in a positive (+) polarity and in a negative (−) polarity and a driving method of such LCD device.

2. Discussion of the Related Art

Generally, a liquid crystal display device controls the light transmittance of liquid crystal molecules using an electric field to display a picture on a liquid crystal panel. The liquid crystal panel includes liquid crystal cells arranged in matrix and a drive circuit to drive the liquid crystal display panel. In a related art liquid crystal display panel, as shown in FIG. 1, gate line GL intersects data line DL, and a thin film transistor TFT for driving a liquid crystal cell is formed at respective intersection of the gate line GL and the data line DL. The data line DL supplies a data voltage Vd. The thin film transistor TFT supplies a data voltage Vd to a pixel electrode Ep of the liquid crystal cell Clc in response to a scan signal Vg supplied through the gate line GL.

A gate electrode of the thin film transistor TFT is connected to the gate line GL, a source electrode is connected to the data line DL, and a drain electrode is connected to the pixel electrode of the liquid crystal cell Clc. The liquid crystal cell Clc is charged with a potential difference between the data voltage Vd supplied to the pixel electrode Ep and the common voltage Vcom supplied to the common electrode Ec. The arrangement of liquid crystal molecules is changed by the electric field generated by this potential difference to control the amount of the light transmit or to block the light. The common electrode Ec is formed on the upper substrate and the lower substrate of the liquid crystal display panel so that the electric field is generated in the liquid crystal cell Clc. And, a storage capacitor Cst is formed between the common electrode Ec and the pixel electrode Ep to maintain a voltage charged in the liquid crystal cell Clc

The related art liquid crystal display panel is operated by an inversion method where the polarity of the data voltage Vd is inverted for a fixed period to prevent the deterioration of the liquid crystal cell Clc. The inversion method includes a dot inversion method, a line inversion method, a column inversion method, and a frame inversion method.

FIG. 2 represents a related art line inversion driving method, where driving voltages are supplied to the liquid crystal display panel. In FIG. 2, ‘Vg’ is a scan signal supplied through the gate line GL, ‘Vd’is a data voltage supplied through the data line DL, ‘Vcom’ is a common voltage supplied to the common electrode Ec of the liquid crystal cells Clc, and ‘Vlc’ is a data voltage that is charged or discharged in the liquid crystal cell Clc.

As shown in FIG. 2, in the related art line inversion driving method, the common voltage Vcom is supplied as a fixed DC voltage, and polarity of data voltage Vd has positive polarity with respect to the Vcom in a horizontal period 1H. In a normally black mode, the transmittance of light through the liquid crystal layer increases when the potential difference between the data voltage Vd and the common voltage Vcom is higher, and the transmittance of light through the liquid crystal layer decreases when the potential difference between the data voltage Vd and the common voltage Vcom is lower. The scan signal Vg swings between a gate high voltage Vgh that turns on the TFT and a gate low voltage Vg1 that turns off the TFT. The liquid crystal cell Clc is charged with the data voltage Vd supplied as a gamma voltage. And, the liquid crystal cell Clc maintains the charged voltage for a fixed period (i.e., scan period) while the scan signal Vg is maintained at the gate high voltage Vgh.

When the TFT maintained in a turned-on state during the scan period changes to a turned-off state, the voltage charged in the liquid crystal cell Clc and the storage capacitor Cst are maintained for a short time. The parasitic capacitor Cgd between the gate electrode and the drain electrode of the TFT contributes to the Clc voltage shift ΔVg. The ΔVp is a kickback voltage or feed-through voltage, and can be generally calculated by a Mathematical Formula shown below. In the Mathematical Formula 1 below, ‘ΔVp’ is a kickback voltage, ‘Cgd’ is a parasitic capacitance between the gate electrode and the drain electrode of the TFT, ‘Clc’ is a capacitance formed in the liquid crystal cell Clc, ‘Cst’ is a capacitance of a storage capacitor Cst, and ‘ΔVg’ is a voltage difference between the gate high voltage Vgh and the gate low voltage Vg1.

ΔVp=Cgd×ΔVg/(Cgd+Clc+Cst) [Mathematical Formula 1]

The liquid crystal cell Clc is charged with a voltage that is lower by ΔVp than the data voltage Vd such as video data (i.e., the liquid crystal cell Clc is charged with a voltage having a potential difference lower by ΔVp than the data voltage Vd in relation to the common voltage Vcom when operated in a positive (+) polarity). The liquid crystal cell Clc is charged with a voltage having a potential difference higher by ΔVp than the data voltage Vd in relation to the common voltage Vcom when operated in a negative (−) polarity. Accordingly, a problem is generated that flickers or residual images appear in a screen of the liquid crystal display panel due to a voltage offset in relation to the common voltage. In the related art liquid crystal device driving method, the common voltage Vcom is adjusted by the voltage offset caused by the kickback voltage ΔVp.

However, while the positive (+) and negative (−) data voltages Vd express the same gray level, a voltage difference Vgd between the data voltage Vd and the gate high voltage Vgh in the positive (+) polarity driving and in the negative (−) polarity driving are different. Accordingly, an amount charged in the parasitic capacitor Cgd in the positive (+) polarity driving is different from the negative (−) polarity driving. And the kickback voltage ΔVp in the positive (+) polarity driving is different from the kickback voltage ΔVp in the negative (−) polarity driving. For example, if the liquid crystal display panel is operated under a driving condition such that a scan signal swings between the gate low voltage Vg1 of −5V and the gate high voltage Vgh of 25V, a common voltage of 7V, and a data voltage Vd of 14V that swings between 0V and 14V, the difference Vgd between the gate high voltage Vgh and the data voltage Vd is 11V in the positive (+) polarity driving, however, the difference Vgd is 25V in the negative (−) polarity driving. In this case, the data voltage Vd=14V represents the white gray level in the positive (+) driving and the data voltage Vd=0V represents a white gray level in the negative (−) driving. From the results of a trial experiment, the kickback voltage ΔVp in the positive (+) driving is 1.121V, and the kickback voltage ΔVp in the negative (−) driving is 1.531V. Accordingly, the difference in the kickback voltage ΔVp between the positive (+) driving and the negative (−) driving is about 400 mV. And, the flickers and residual images phenomena worsen as the difference in the kickback voltage ΔVp increases. In the related art LCD driving method, adjusting the common voltage Vcom is implemented to control the above problems. However, adjusting Vcom has its limit.

### SUMMARY OF THE INVENTION

Accordingly, the present invention is directed to a liquid crystal display and driving method thereof that substantially obviates one or more of the problems due to limitations and disadvantages of the related art.

An object of the present invention is to provide a liquid crystal display (LCD) device that improves a display quality by reducing a difference in a kickback voltage when the LCD is operated in a positive polarity driving and in a negative polarity driving.

Another object is to provide an inversion driving method that achieves reduction of the kickback voltage difference.

Additional features and advantages of the invention will be set forth in part in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a liquid crystal display device includes data lines and gate lines on a substrate intersecting each other to define a plurality of pixel areas; a plurality of liquid crystal cells formed in respective pixel areas; a data driver that generates a positive and a negative data signals, the data driver supplies desired data signals to the data lines; a gate driver that supplies a scan signal to the gate lines, wherein a voltage level of the scan signal is changed in accordance with a polarity of the data signal; and a plurality of thin film transistors formed at respective intersections of gate lines and data lines, the thin film transistor supplying the data signal to the liquid crystal cell in response to the scan signal.

In another aspect, a driving method of a liquid crystal display device includes generating a positive data signal and a negative data signal and supplying the data signals to data lines of a liquid crystal display panel; and supplying a scan signal to gate lines of the liquid crystal display panel, wherein a voltage level of the scan signal is changed in accordance with a polarity of the data signal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a diagram illustrating a pixel cell included in a related art liquid crystal display panel;

FIG. 2 is a diagram illustrating driving signal voltages for related art pixel cell of FIG. 1;

FIG. 3 is a diagram illustrating a liquid crystal display device according to an exemplary embodiment of the present invention;

FIG. 4 is a diagram detailing a configuration of an exemplary gate driver of FIG. 3;

FIGS. 5 and 6 are diagrams detailing a circuit and a driving signal waveform of the exemplary gate driver of FIG. 4;

FIGS. 7A and 7B are diagrams explaining an exemplary line inversion driving method;

FIGS. 8A and 8B are diagrams illustrating a driving signal waveforms in the exemplary line inversion driving method of the liquid crystal display device according to the exemplary embodiment of the present invention;

FIGS. 9A and 9B are diagrams explaining an exemplary frame inversion driving method; and

FIGS. 10A and 10B are diagrams illustrating driving signal waveforms in the exemplary frame inversion driving method of the liquid crystal display device according to the exemplary embodiment of the present invention.

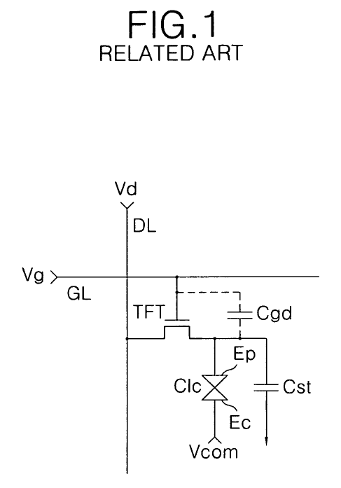

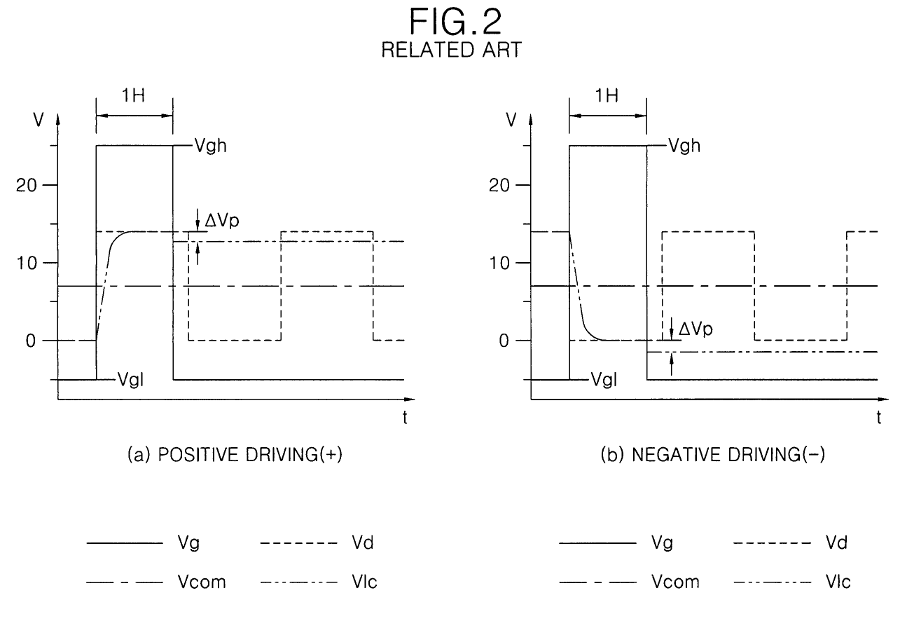

### DETAILED DESCRIPTION OF THE PREFERRED EMBODIMENTS

Reference will now be made in detail to the preferred embodiments of the present invention, examples of which are illustrated in the accompanying drawings.

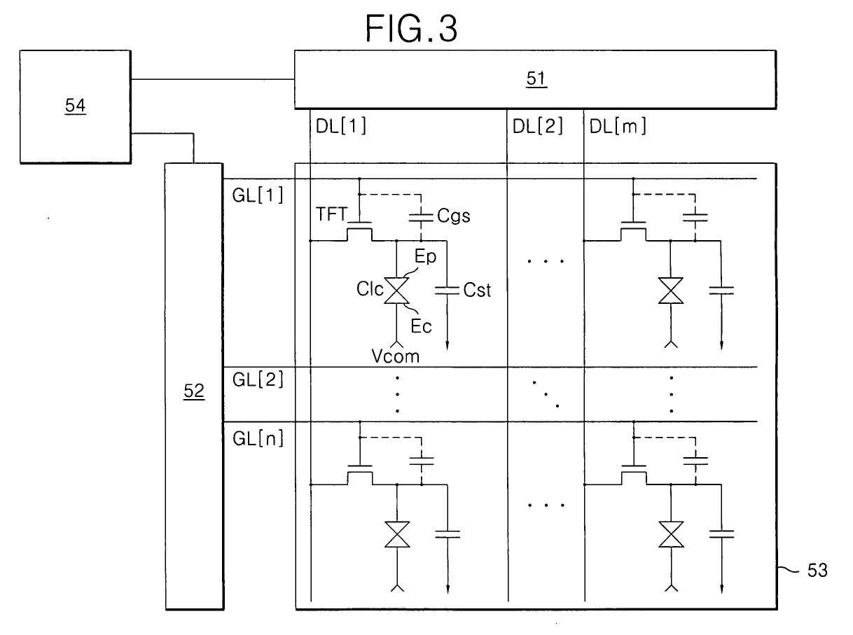

Exemplary embodiments of the present invention will be explained with reference to FIGS. 3 to 10B. As shown in FIG. 3, an exemplary liquid crystal display device includes a liquid crystal display panel where a plurality of gate lines GL1 to GLn (n is a positive integer) intersect a plurality of data lines DL1 to DLm (m is a positive integer) to define a plurality of pixel areas, liquid crystal cells Clc formed in respective pixel areas, and a thin film transistor TFT formed at respective intersection of the gate lines GL1 to GLn and the data lines DL1 to DLm to drive a liquid crystal cell Clc; a data driver 51 to supply a video signal to the data lines DL1 to DLm; a gate driver 52 for supplying a scan signal to the gate lines GL1 to GLn, and a timing controller 54 to control the data driver 51 and the gate driver 52.

The liquid crystal display panel is formed in a structure where an upper substrate is bonded with a lower substrate. The gate lines GL1 to GLn and the data lines DL1 to DLm are formed on in the lower substrate of the liquid crystal display panel 53. The TFT formed at respective intersection of the gate lines GL1 to GLn and the data lines DL1 to DLm supplies a data voltage Vd from the jth data line DL[j] (1=j=m) to the pixel electrode Ep of the liquid crystal cell Clc. The data voltage Vd is supplied in response to the scan signal Vg[k] from the kth gate line GL[k] (1=k=n). The gate electrodes of the TFT are connected to the gate lines GL1 to GLn, drain electrodes are connected to the data lines DL1 to DLn, and source electrodes are connected to the pixel electrodes Ep of the liquid crystal cells Clc.

The liquid crystal cell Clc is charged with a potential difference between the data voltage Vd supplied to the pixel electrode Ep and the common voltage Vcom supplied to the common electrode Ec. This potential difference generates the electric field to change the arrangement of the liquid crystal molecules. Accordingly, amount of light transmit or light blocked is controlled. The common electrode Ec is formed on the upper substrate or on the lower substrate. Location where the common electrode Ec is formed in the liquid crystal cell Clc is determined by how the electric field is applied to the liquid crystal cell Clc. A storage capacitor Cst is formed between the pixel electrode Ep and the common electrode Ec and maintains a voltage charged to the liquid crystal cell Clc. In addition, the storage capacitor Cst may be formed between the pre-stage gate line GL(k-1) and the pixel electrode Ep of the liquid crystal cell Clc. A color filter for realizing color, a black matrix for reducing light interference between adjacent pixels, and other necessary components are formed on the upper substrate of the liquid crystal display panel 53. Further, polarizers having light axes at right angles to each other are adhered to the upper substrate and the lower substrate respectively. And, an alignment film for setting a pre-tilt angle of the liquid crystal molecules is formed on surfaces of the upper and lower substrates that faces each other.

The timing controller 54 receives a digital video data RGB, vertical/horizontal synchronization signals, and other suitable signals and generates a gate control signal GDC and a data control signal DDC. The gate control signal GDC controls the gate driver 52 and the data control signal DDC controls the data driver 51. And, the timing controller 54 re-aligns the digital video data in accordance with the clock signal to supply the DDC to the data driver 51. The gate control signal GDC includes a gate start pulse GSP, a gate shift clock GSC, a gate output signal GOE, and other suitable signals. The data control signal DDC includes a source start pulse SSP, a source shift clock SSC, a source output signal SOE, a polarity control signal POL, and other suitable signals.

The data driver 51 converts the digital video data into an analog gamma compensation voltage (i.e., a data voltage Vd) and supply to the data lines DL1 to DLm. The data driver 51 includes a shift register for sampling the clock signal, a register for temporally storing the digital video data, a latch for storing the data for each line in response to the clock signal and at the same time outputting the stored data, a digital/analog converter for selecting a positive/negative gamma voltage in correspondence with the digital data value from the latch, a multiplexer for selecting the data line DL[j] to which the analog data converted by the positive/negative gamma voltage are supplied, and an output buffer connected between the multiplexer and the data line DL[j].

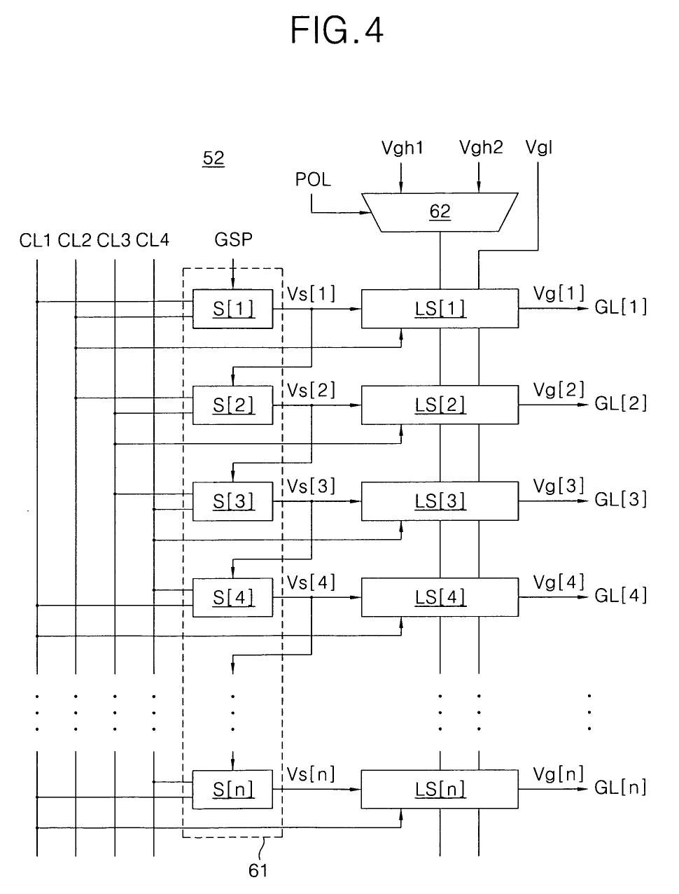

As shown in FIG. 4, the gate driver 52 includes a shift register 61 for sequentially shifting the gate start pulse GSP to generate the shift output signal Vs1 to Vsn, level shifters LS1 to LSn for converting the shift output signal Vs1 to Vsn into the scan signal Vg1 to Vgn (i.e., voltage having a level suitable for driving the TFT) and supply to the gate lines GL1 to GLn, and a voltage selector 62 for supplying a reference voltage required to convert the voltage level of the level shifter LS1 to LSn.

The shift register 61 includes a plurality of stages connected in a cascade manner. The first stage S1 receives the gate start pulse GSP and the remaining stages S2 to Sn receive the shift output signals Vs1 to Vsn-1 output from the previous stages S1 to Sn-1 as an input signal. The shift output signals Vs1 to Vsn are shifted by one clock (i.e., one horizontal period). In detail, the gate start pulse GSP is supplied to the first stage S1 as the input signal and the clock is shifted and the shift output signal Vs1 is output. The shift output signal Vs1 is supplied to the next stage S2 as an input and the clock is shifted again. The second stage S2 outputs the shift output signal Vs2 and is supplied to the third stage S3 as an input, and this continues until the nth stage Sn. The input terminal of the kth stage Sk, except the first stage S1, is connected to the output terminal Vs[k-1] of the (k-1)th stage S[k-1].

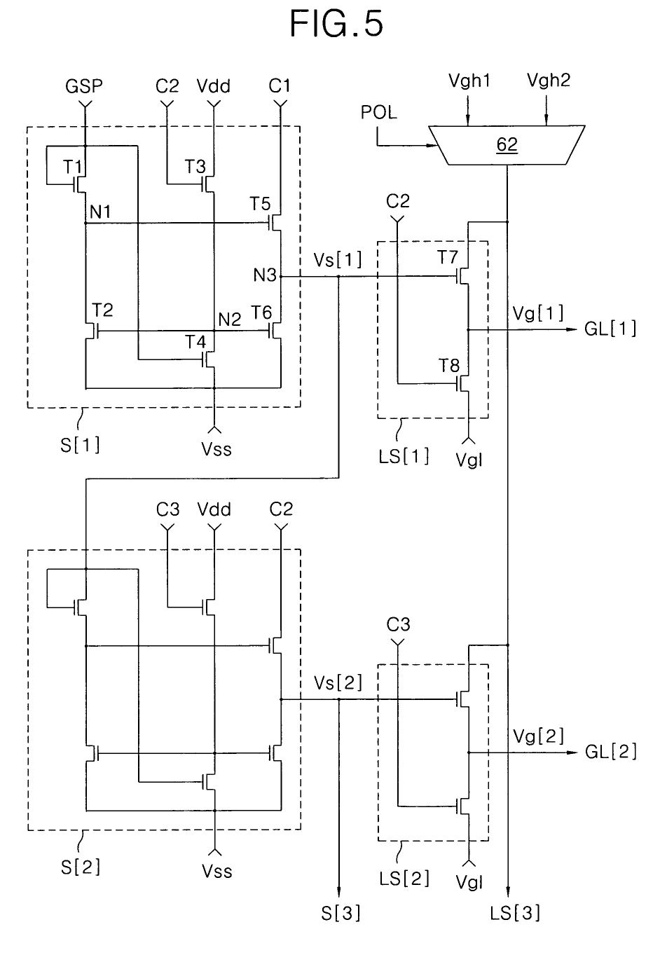

Each level shifter to LSn converts the shift output signal Vs1 to Vsn output from the stage S1 to Sn of the shift register 61 into the scan signal Vg1 to Vgn. The scan signals Vg1 to Vgn swings between the gate low voltage Vg1 and one of the first and second gate high voltages Vgh1 and Vgh2. As shown in FIGS. 4 and 5, the voltage selector 62 selects either the first or second gate high voltages Vgh1 and Vgh2, and selected voltage is supplied to the level shifters LS1 to LSn and the gate lines GL1 to GLn. The first and second gate high voltages Vgh1 and Vgh2 have voltage levels greater than a threshold voltage of the TFT (i.e., a gate-on voltage). The gate low voltage Vg1 has a voltage level less than the threshold voltage of the TFT's (i.e., a gate-off voltage). And, the gate low voltage Vg1 is supplied from an external voltage source.

The voltage selector 62 receives the first and second gate high voltages Vgh1 and Vgh2 from the external voltage source and selects one of the first and second gate high voltage Vgh1 and Vgh2 in accordance with the polarity signal POL received from the timing controller 51. The selected gate high voltage is supplied to the level shifter LS1 to LSn. The first gate high voltage Vgh1 and the second gate high voltage Vgh2 have different voltage levels from each other. Assuming that the first gate high voltage Vgh1 has a higher voltage level than the second gate high voltage Vgh2, the voltage selector 62 selects the first gate high voltage Vgh1 in response to the positive polarity signal POL and selects the second gate high voltage Vgh2 in response to the negative polarity signal POL.

TABLE 1 below lists results of a trial experiment. Differences in the kickback voltage ΔVp are listed by fixing the voltage level of the first gate high voltage Vgh1 and changing the voltage level of the second gate high voltage Vgh2. As shown in TABLE 1, a difference in the kickback voltage ΔVp between the positive (+) driving and the negative (−) driving is 410 mV when the first and second gate high voltages Vgh1 and Vgh2 are identically set at 25V. However, a difference in the kickback voltage ΔVp becomes 6 mV when the first gate high voltage Vgh1 is set at 25V and the second gate high voltage Vgh2 is set at 17.7V. Accordingly, implementing the gate-on voltage in the positive (+) driving to be different from the gate-on voltage in the negative (−) driving (i.e., setting the gate-on voltage in the negative (−) driving lower than the gate-on voltage in the positive (+) driving) substantially reduces the difference in the kickback voltage ΔVp. The liquid crystal display device has a minimum voltage level required for operation. Such minimum voltage level is different for types and sizes of the LCD devices, thus the second gate high voltage Vgh2 should be set to an optimized value determined experimentally.

TABLE 1

| | | | | | | Difference in ΔVp |
|---|---|---|---|---|---|---|
| | | | | | | between |
| | | | | | | positive (+) driving |
| Polarity signal | Vg[k] | | | Vgd | | and |
| (POL) | Vgl | Vgh | Vd | (Vgh − Vd) | ΔVp | negative (−) driving |
| Positive (+) | −5 V | 25 V | 14 V | 11 V | 1.121 V | — |
| Vgh1 | | | | | | |
| Negative (−) | −5 V | 25 V | 0 V | 25 V | 1.531 V | 410 mV |
| Vgh2 | −5 V | 22 V | 0 V | 22 V | 1.3697 V | 248 mV |
| | −5 V | 20 V | 0 V | 20 V | 1.2525 V | 131 mV |
| | −5 V | 18 V | 0 V | 18 V | 1.1443 V | 23 mV |
| | −5 V | 17.7 V | 0 V | 17.7 V | 1.1275 V | 6 mV |

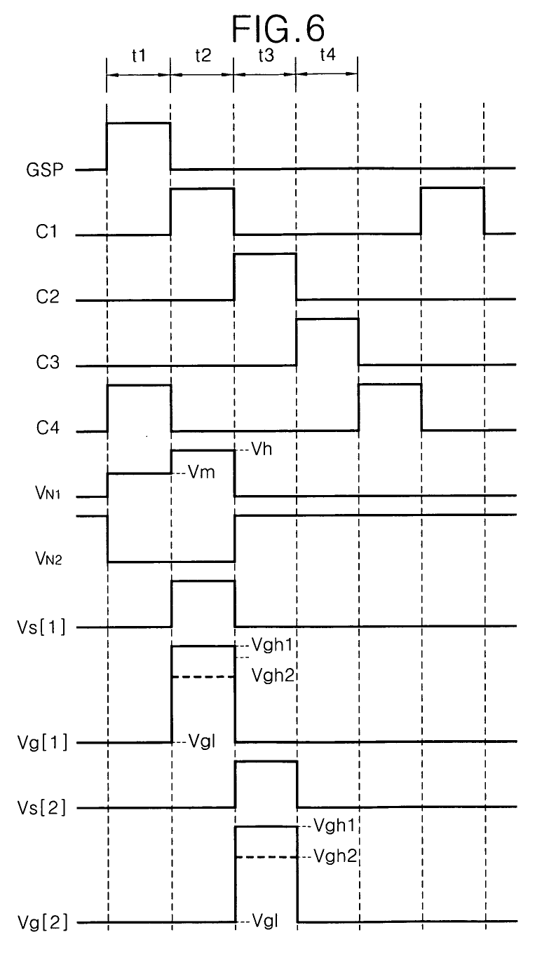

FIG. 5 illustrates an exemplary circuit configuration of the first and second level LS1, LS2 and the first and second stages S1, S2 of the shift register 61 in the gate driver 52. FIG. 6 shows waveforms of the driving signals. The operation of the gate driver 52 will be explained in reference to FIGS. 5 and 6. The second to nth stages S2 to Sn of the shift register 61 has the same circuit configuration as the first stage S1 except the input signals. While the gate start pulse GSP is supplied to the first stage S1 as an input signal, the output signal Vs1 to Vs[n-1] output from the stages S1 to S[n-1] is supplied as the shift input signal to the stages S2 to Sn-1. Similar to stages of the shift register 61, the second to nth level shifter LS2 to LSn also have the same circuit configuration as the first level shifter LS1. Accordingly, operation of the first level shifter LS1 and the first stage S1 of the shift register 61 will be explained.

As shown in FIGS. 5 and 6, the gate start pulse GSP is supplied to the gate electrode of the first and fourth transistors T1, T4 as a high logic voltage for a t1 period. The first and second clock signals C1, C2 are maintained at a low logic voltage in t1 period, thereby turning on the first and fourth transistors T1, T4. At this moment, a voltage VN1 on the first node N1 is increased to an intermediate voltage Vm to turn on a fifth transistor T5, however, since the first clock signal C1 is maintained at the low logic voltage, the voltage on the third node N3 (i.e., the first shift output voltage Vs1) is maintained at the low logic voltage. At the same time, the voltage VN2 on the second node N2 is decreased by the turned-on fourth transistor T4 to turn off a second transistor T2 and a sixth transistor T6, thereby blocking a discharge path of the first and third node N1, N3.

Next, at a t2 period, the gate start pulse GSP is inverted to the low logic voltage, however, the first clock signal C1 is inverted to the high logic voltage. At this moment, the first transistor T1 and the fourth transistor T4 are turned off and the voltage VN1 on the first node N1 is increased to a voltage level greater than the threshold voltage of the fifth transistor T5. This is because the voltage charged in the parasitic capacitance between the drain electrode and the gate electrode of the fifth transistor T5 due to the first clock signal C1 (i.e., high logic voltage) is added to the VN1. The voltage VN1 on the first node N1 is increased to a voltage that is higher than that of the t1 period by bootstrapping. Accordingly, in a t2 period, the fifth transistor T5 is turned on and the first shift output signal Vs1 is increased by the voltage of the first clock signal C1. The voltage of the first clock signal C1 is supplied by the conduction of the fifth transistor T5 so that Vs1 is inverted to the high logic voltage.

When the shift output signal Vs1 of the first stage S1 is inverted to the high logic voltage, a seventh transistor T7 of the first level shifter LS1 is turned on and the first gate high voltage Vgh1 or the second gate high voltage Vgh2 are supplied to the first gate line GL1. The first or the second gate high voltage Vgh1, Vgh2 supplied to the first gate line GL1 turns on the respective thin film transistors TFT, thereby supplying the data voltage Vd to the liquid crystal cell Clc.

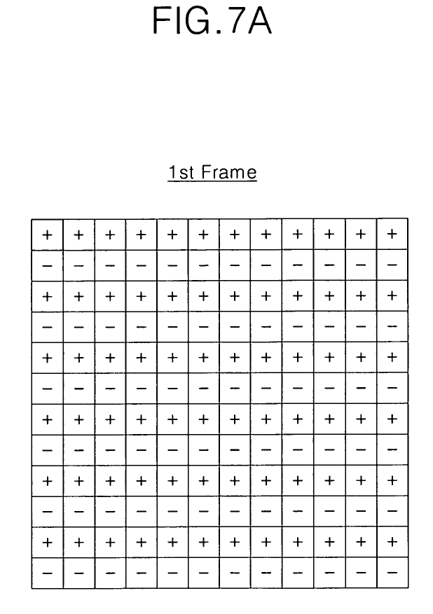

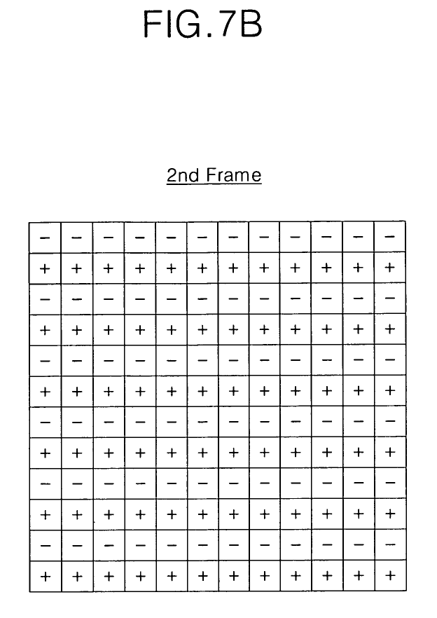

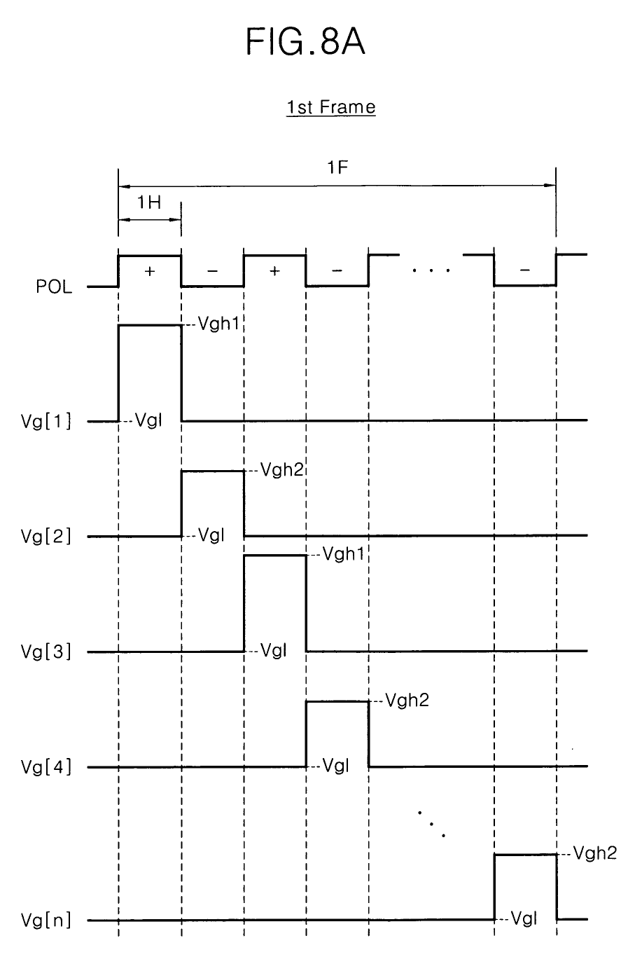

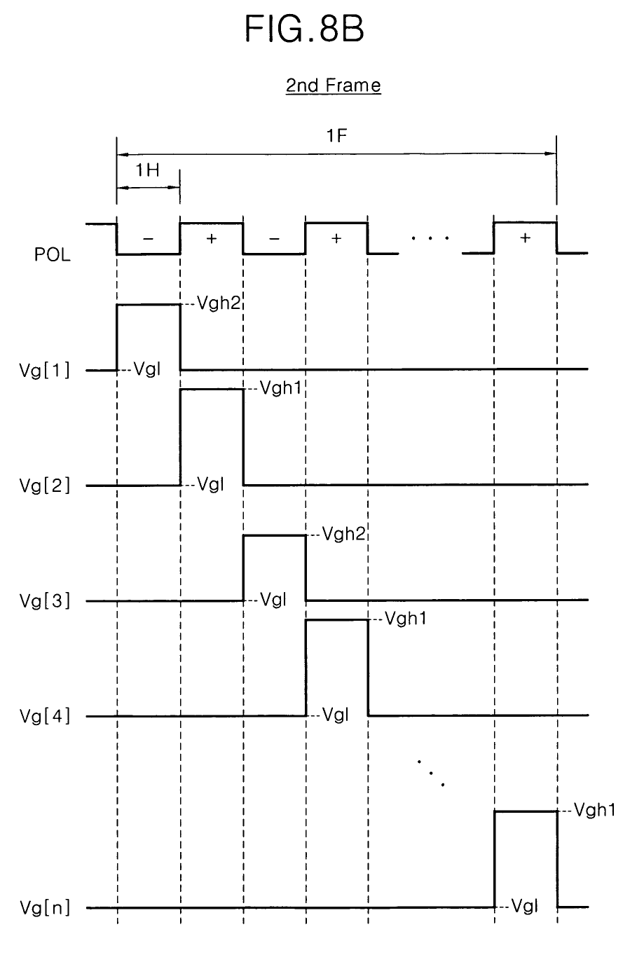

The gate-on voltage supplied to the gate line GL1 is selected by the voltage selector 62 in accordance with the polarity signal POL as described above. The polarity signal POL has a different inversion cycle in accordance with an exemplary line inversion method. In the exemplary line inversion method, as shown in FIGS. 7A and 7B, polarity of the POL signal of each horizontal period is alternatively inverted, thereby a data signal having same polarity is supplied to the liquid crystal cells that are adjacent to each other in a vertical direction and are parallel to the gate line, and the data signal having a different polarity is supplied to the liquid crystal cells which are adjacent to each other in a horizontal direction and are parallel to the data line. In addition, the POL signal between frame periods is alternatively inverted. The voltage selector 62 selects the first or the second gate high voltage Vgh1 or Vgh2 in accordance with the polarity signal POL, and the scan signals Vg1 to Vgn are sequentially supplied to the gate lines GL1 to GLn. FIGS. 8A and 8B shows the waveforms of signals in relation to the POL signals in the exemplary line inversion method.

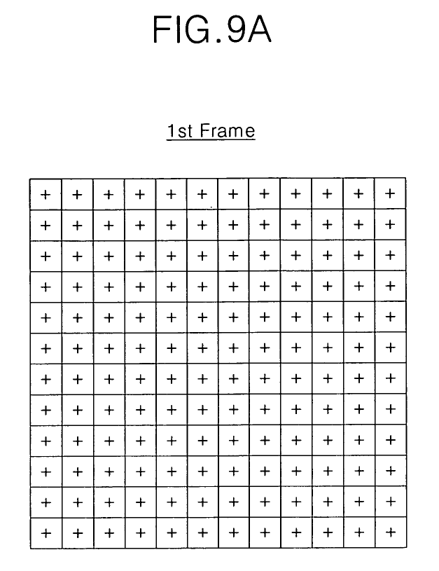

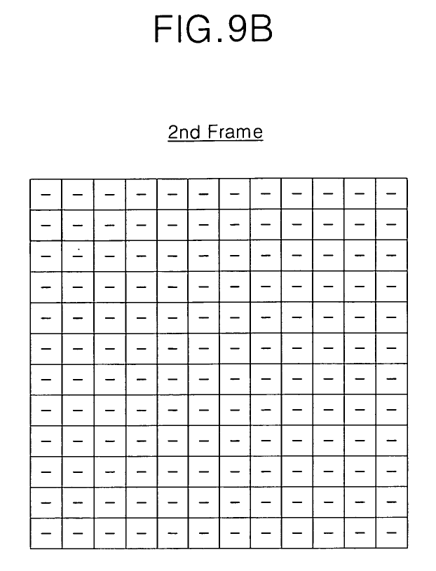

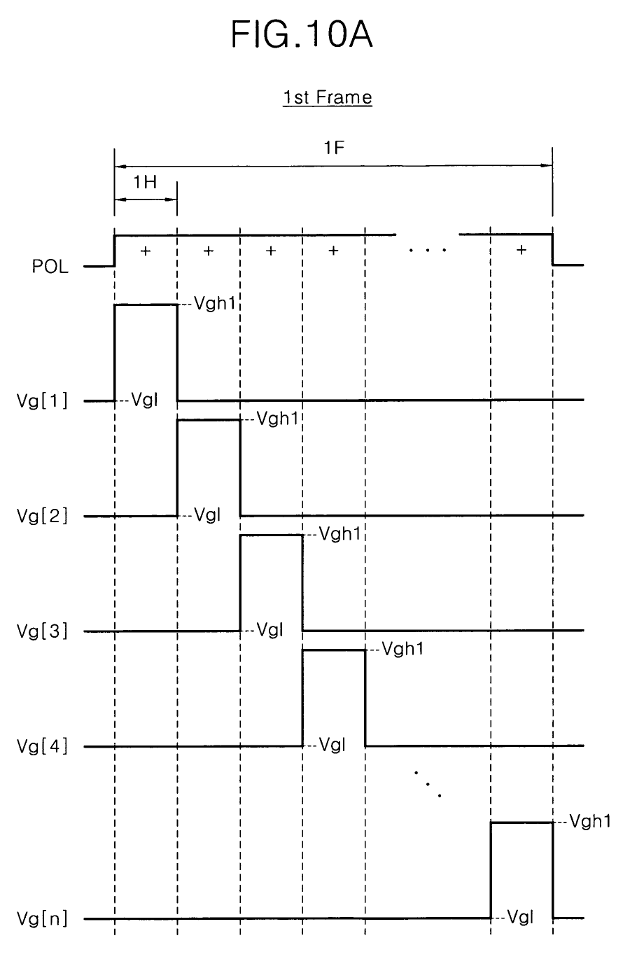

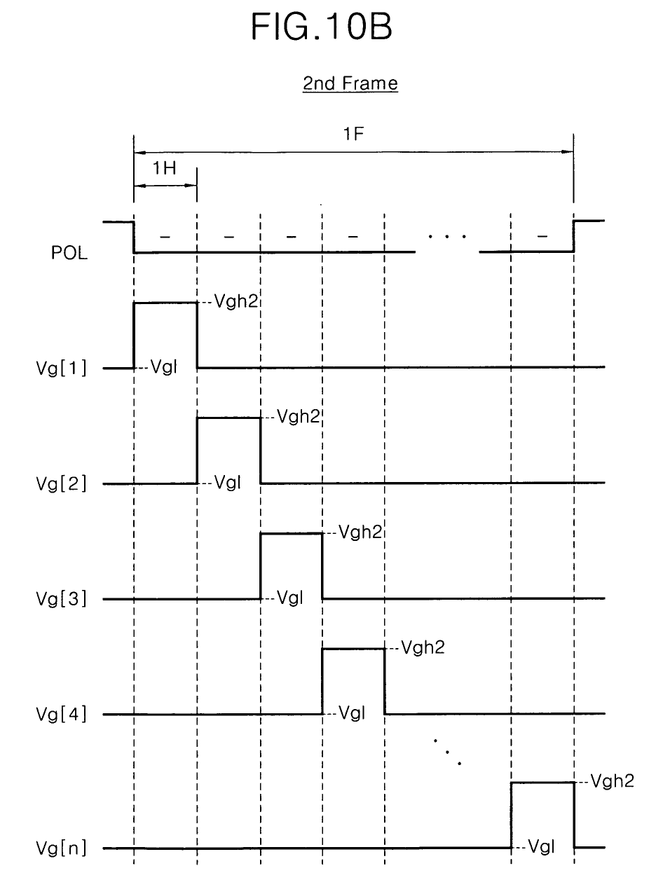

In an exemplary frame inversion method, as shown in FIGS. 9A and 9B, polarity of the POL signal is alternatively inverted between each frame period. The voltage selector 62 selects the first or the second gate high voltage Vgh1 or Vgh2 in accordance with the polarity signal POL, and the scan signals Vg1 to Vgn are sequentially supplied to the gate lines GL1 to GLn. FIGS. 10A and 10B shows the waveforms of signals in relation to the POL signals in the exemplary frame inversion method. The frame period is also called a field period. The filed period is a display period of one screen when data are applied to all the pixels of the one screen. In an NTSC system, the standard frame period is set to be 1/60 seconds. In a PAL system, the standard frame period is set to be 1/50 seconds.

As shown in FIG. 6, the first clock signal C1 is inverted to the low logic voltage and the second clock signal C2 is inverted to the high logic voltage in a t3 period. At this moment, the third transistor T3 is turned on and the high potential power voltage Vdd is supplied to the second node N2 to increase the voltage VN2. The voltage VN2 on the second node N2 turns on the second transistor T2 to discharge the voltage VN1 on the first node N1 to a ground voltage Vss. At the same time, the sixth transistor T6 is turned on to discharge the voltage on the third node N3 to the ground voltage Vss. If the voltage on the third node N3 is discharged to the ground voltage Vss (i.e., the shift output signal Vs1 of the first stage S1 is inverted to the low logic voltage), then the seventh transistor T7 of the first level shifter LS1 is turned off. At this moment, the eighth transistor T8 of the first level shifter LS1 is turned on by the second clock signal C2 to supply the gate low voltage Vg1 to the first gate line GL. The gate low voltage Vg1 supplied to the first gate line GL1 turns off the corresponding thin film transistors TFT.

Next, in a t4 period, when the second clock signal C2 is inverted to the low logic voltage, the third transistor T3 is turned off. At this moment, the high logic voltage is floated on the second node N2. The high logic voltage floated on the second node N2 is maintained until the fourth transistor T4 is turned on by the gate start pulse GSP in the next frame period to discharge the voltage floated on the second node N2.

The shift register 61 and the level shifters LS1 to LSn in the gate driver 52 shown in FIG. 4, and driving method shown FIGS. 5 and 6 are not limited and can be replaced with another shift register, level shifters, and driving circuits. As described above, the liquid crystal display device and the driving method thereof according to the exemplary embodiment of the present invention sets the gate-on voltage in the negative (−) driving lower than the gate-on in the positive (+) driving to reduce the difference in the kickback voltage ΔVp. Accordingly, the flickers and the residual images phenomena is prevented and the display quality of the liquid crystal panel is improved.

It will be apparent to those skilled in the art that various modifications and variations can be made in the liquid crystal display device and driving method thereof of the present invention without departing from the spirit or scope of the invention. Thus, it is intended that the present invention cover the modifications and variations of this invention provided they come within the scope of the appended claims and their equivalents.

What is claimed is:

1. A liquid crystal display device, comprising:
data lines and gate lines on a substrate intersecting each other to define a plurality of pixel areas;
a plurality of liquid crystal cells formed in respective pixel areas;
a data driver that generates a positive and a negative data signals, the data driver supplying desired data signals to the data lines;
a gate driver that supplies a scan signal to the gate lines, wherein a voltage level of the scan signal is changed in accordance with a polarity of the data signal; and
a plurality of thin film transistors formed at respective intersections of gate lines and data lines, the thin film transistor supplying the data signal to the liquid crystal cell in response to the scan signal.

2. The liquid crystal display device according to claim 1, wherein the scan signal includes:
a first scan signal, such that the level of voltage changes with a first swing level when a polarity signal is positive; and
a second scan signal, such that the level of voltage changes with a second signal level when the polarity signal is negative, wherein the second swing level is less than the first swing level.

3. The liquid crystal display device according to claim 2, wherein the first scan signal has a first gate high voltage not less than a threshold voltage of the thin film transistor and a gate low voltage less than the threshold voltage of the thin film transistor, and the second scan signal has the gate low voltage and a second gate high voltage between the threshold voltage of the thin film transistor and the first gate high voltage.

4. The liquid crystal display device according to claim 3, wherein the gate driver includes:
a shift register that generates a shift pulse and sequentially shifts the shift pulse by unit of the gate line; and
a level shifter that adjusts a swing level of the shift pulse to one of the first swing level of the first scan signal and the second swing level of the second scan signal in accordance with the polarity of the data signal, and supplies the adjusted swing level to the gate lines.

5. The liquid crystal display device according to claim 1, wherein the data signal having same polarity is supplied to the liquid crystal cells that are adjacent to each other in a vertical direction and are parallel to the gate line, and the data signal having a different polarity is supplied to the liquid crystal cells which are adjacent to each other in a horizontal direction and are parallel to the data line.

6. The liquid crystal display device according to claim 1, wherein the data signal has its polarity inverted for each frame period.

7. A driving method of a liquid crystal display device, comprising the steps of:
generating a positive data signal and a negative data signal and supplying the data signals to data lines of a liquid crystal display panel; and
supplying a scan signal to gate lines of the liquid crystal display panel, wherein a voltage level of the scan signal is changed in accordance with a polarity of the data signal.

8. The driving method according to claim 7, wherein the scan signal includes:
a first scan signal, such that the level of voltage changes with a first swing level when a polarity signal is positive; and
a second scan signal, such that the level of voltage changes with a second signal level when the polarity signal is negative, wherein the second swing level is less than the first swing level.

9. The driving method according to claim 8, wherein the first scan signal has a first gate high voltage not less than a threshold voltage of the thin film transistor and a gate low voltage is less than the threshold voltage of the thin film transistor, and the second scan signal has the gate low voltage and a second gate high voltage between the threshold voltage of the thin film transistor and the first gate high voltage.

10. The driving method according to claim 7, wherein the data signal having same polarity is supplied to liquid crystal cells that are adjacent to each other in a vertical direction and are parallel to the gate line, and the data signal having a different polarity is supplied to the liquid crystal cells that are adjacent to each other in horizontal direction and are parallel to the data line.

11. The driving method according to claim 7, wherein the data signal has its polarity inverted for each frame period.
